(19) United States
(12) Patent Application Publication
(10) Pub. No.: US 2015/0174681 A1
(43) Pub. Date: Jun. 25, 2015

(54) Integrated Controller/Power Source for an Arc Welding Apparatus

(71) Applicant: Tri Tool, Inc., Rancho Cordova, CA (US)

(72) Inventors: Dale A. Flood, El Dorado Hills, CA (US); Daniel Hatter, Blue Ridge, VA (US)

(21) Appl. No.: 14/581,070

(22) Filed: Dec. 23, 2014

Related U.S. Application Data
(60) Provisional application No. 61/919,953, filed on Dec. 23, 2013.

(51) Int. Cl. B23K 9/10

(52) U.S. Cl. CPC B23K 9/1087; B23K 9/1068; B23K 9/1006

(57) ABSTRACT

A conventional arc welder control console is integrated with a portable engine-powered weld current generator to eliminate the need for a separate large, high current, 3 phase AC electrical generator when the arc welder is used in the field.

This application claims the benefit of U.S. Provisional Patent Application Ser. No. 61/919,953, filed Dec. 23, 2013.

### BACKGROUND OF THE INVENTION

1. Field of the Invention

The present invention relates to an integrated controller/power source for an orbital arc welding apparatus. The integrated controller/power source eliminates the need for a separate AC power generator. By way of background, a prior orbital arc welding apparatus is described in U.S. Pat. No. 7,180,028, issued on Feb. 20, 2007.

2. Description of Related Art

Orbital arc welders are typically used in installations having a fixed power source. However, it is possible to use orbital arc welders in remote locations, such as on farms and cross country pipelines, that lack access to an appropriate fixed power source. In that case, the orbital arc welder must conventionally be powered by a separate gasoline or diesel powered generator. The generator is typically a three-phase AC power generator that is too large and unwieldy to be set up at the welding site solely by the welding apparatus operator.

### SUMMARY OF THE INVENTION

The present invention integrates a conventional orbital arc welder control console with a portable engine-powered weld current generator to eliminate the need for a separate large, high current, 3 phase AC electrical generator when the orbital arc welder is used in the field. For example, instead of a 460 amp, 3 phase power source, the integrated controller/power source of the invention may utilize a gasoline or diesel-engine driven weld current generator.

An example of an orbital welding control system to which the principles of the invention may be applied is the Tri Tool, Inc. ORBITMASTER® advanced programmable multi-process welding arc controller, although the principles of the invention are not limited to the ORBITMASTER® controller.

According to a preferred embodiment of the invention, the weld current generator includes a multiple-pin remote control input connector for remotely controlling the current output of the generator. Integration of the weld controller is achieved by plugging the weld control console into the multiple-pin connector to enable the welder control console to control the current supply to the weld head. Movement of the weld head, on the other hand, is controlled in conventional fashion via a conventional direct connection between the weld control console and the welding apparatus.

An advantage of integrating an orbital system with an engine driven power source is that it reduces fuel consumption and carbon footprint. This is because in a conventional stick welding (SMAW) or MIG (GMAW-S or GMAW-P) welding arrangement that utilizes a separate, independently-controlled power source, the operator will normally energize the power source and leave it running all day so it will produce the weld current on demand. Because of the nature of orbital welding and the design of the ORBITMASTER® arc welding controller, on the other hand, the operator can remotely signal the power source by way of the welding pendant start button prior to the need for a welding arc and start (energize) the engine. Additionally, the integrated arrangement permits the operator to remotely signal the power source by way of the console program or the welding pendant stop button to stop (de-energize) the engine and save substantial quantities of fuel and reduce environmental impact.

While particularly applicable to orbital arc welders, the principles of the invention may be applied to welding apparatus other than orbital arc welders that are conventionally utilized in fixed installations, and that are controlled through a separate system control console.

Although the weld current generator of the illustrated embodiment is a gasoline or diesel powered generator, the generator may also utilize compressed natural gas, propane, methane, biofuels, and so forth, and therefore is not limited to a particular type of fuel.

### BRIEF DESCRIPTION OF THE DRAWINGS

FIG. 1 is an isometric view of an integrated controller/power source for an arc welding apparatus according to a preferred embodiment of the invention.

### DETAILED DESCRIPTION OF THE PREFERRED EMBODIMENTS

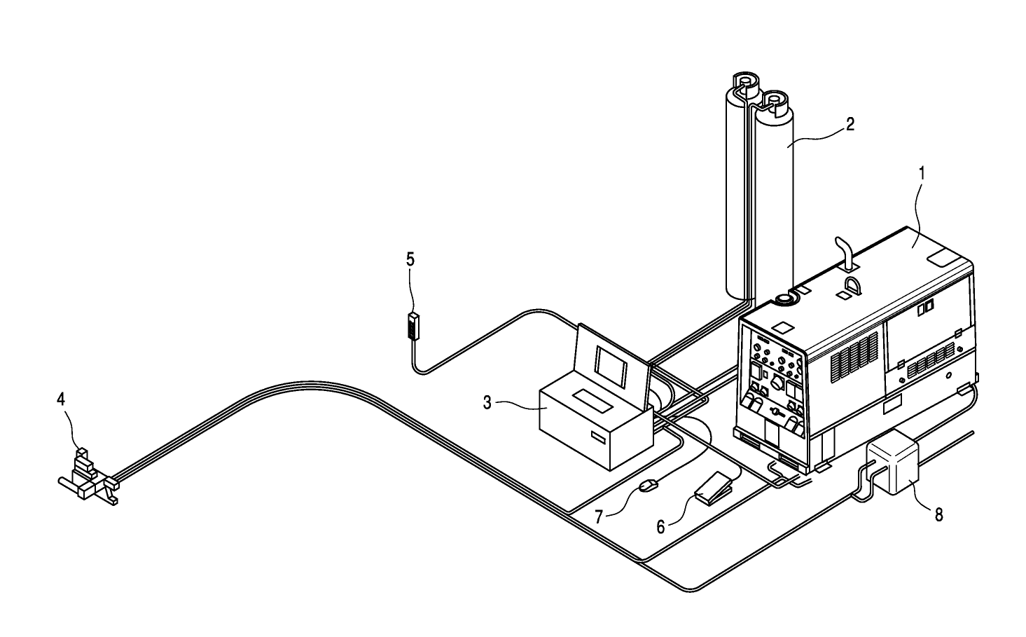

As illustrated in FIG. 1, the controller/power source of a preferred embodiment of the present invention includes a portable weld current generator 1. Examples of a suitable portable engine-driven weld current generator 1 include the Big Blue® 700 Duo Pro™ and Big Blue® 800 Duo Pro™ generators manufactured and sold by Miller Electric Mfg. Co. and described in the brochure entitled “Diesel-Engine-Driven Welder/AC Generator” (June 2012). The Miller Electric Mfg. Co. Big Blue® 700 Duo Pro™ generator has dual 20 to 400 amp outputs, which may be paralleled to output 20 to 800 amps, and includes a standard 14-pin receptacle for connection of a remote controller and/or wire feeder.

An advantage of using the Big Blue® 700 or 800 Duo Pro™ generators is that two orbital welding systems may be simultaneously connected to and supplied with power from a single weld current generator. As a result, one weld head can weld the left side of a pipe while another is welding the right side of the pipe, so that the weld can be finished in half the time. It is to be understood, however, that the invention is not limited to the Big Blue® 700 or 800 Duo Pro™ generator, but rather may be applied to other portable engine-powered generators (either DC or AC with an inverter), so long as the portable engine-powered generator includes a suitable remote control input connector or receptacle.

According to the preferred embodiment of the invention, instead of plugging a remote controller into the standard 14-pin receptacle, an orbital arc welding system control console 3 is plugged into the 14-pin receptacle, to control the current supply to the weld head.

The system control console 3 is then connected in conventional fashion to the weld head 4, remote pendant 5, optional foot pedal 6, and additional input devices such as a mouse 7. Movement of the weld head 4 is controlled directly by the system control console 3 in conventional fashion, as is supply of welding gas from an inert gas supply 2. The weld current generator 1 also supplies power to a water cooler 8 connected in conventional fashion to a water source and to the weld head. Control console 3 may, by way of example and not limitation, be the control console of the above-mentioned ORBITMASTER® advanced programmable multi-process welding arc controller.

We claim:

1. An integrated controller/power source for an arc welding apparatus, comprising:
a portable engine-driven weld current generator including a multiple pin remote-control input connector; and
a system control console connected to a weld head of the arc welding apparatus, wherein:
supply of current to the weld head is controlled via a connection between the system control console and the multiple pin remote-control input connector.

2. An integrated controller/power source for an arc welding apparatus as claimed in claim 1, wherein the portable weld current generator is a gasoline or diesel powered generator.

3. An integrated controller/power source for an arc welding apparatus as claimed in claim 1, wherein the multiple pin remote-control input connector is a 14-pin input connector.

4. An integrated controller/power source for an arc welding apparatus as claimed in claim 1, wherein the welding apparatus is an orbital arc welding apparatus.

5. An integrated controller/power source for an arc welding apparatus as claimed in claim 1, wherein control of a welding operation is carried out by a remote pendant and optional foot pedal connected to the system control console.

6. An integrated controller/power source for an arc welding apparatus as claimed in claim 1, wherein the welding pendant or control console supplies a signal to energize and de-energize the weld-current generator as needed for a welding operation.

7. An integrated controller/power source for an arc welding apparatus as claimed in claim 1, wherein said weld current generator includes two power outlets to enable simultaneous welding by two orbital welding systems.
